(19) United States
(12) Patent Application Publication
(10) Pub. No.: US 2026/0330960 A1
(43) Pub. Date: Oct. 22, 2026

(54) SYSTEMS FOR AND METHODS OF EDGE AI SENSOR FUSION TO DETECT AND RESPOND TO INCIDENTS OF INTEREST

(71) Applicant: EyeZense, Inc., Newark, CA (US)

(72) Inventors: Steven Yung, Newark, CA (US); Kejie Bao, Sunnyvale, CA (US); Jing Li, Newark, CA (US); Yijiang Lu, Newark, CA (US); Phillip Doan, San Jose, CA (US); Sharvan Kumar, Newark, CA (US); Jun Kai Hsu, Newark, CA (US)

(21) Appl. No.: 19/465,097

(22) Filed: Jan. 30, 2026

Related U.S. Application Data
(60) Provisional application No. 63/752,477, filed on Jan. 31, 2025.

(51) Int. Cl. G08B 29/18; G08B 25/14

(52) U.S. Cl. CPC G08B 29/188; G08B 25/14

(57) ABSTRACT

The present disclosure relates to the fusion of “see, hear, smell” edge AI sensors in a sensor device to detect and respond to incidents of interest. Upon incident detection, an edge AI server or a cloud server triggers alerts and dispatches human operators, or autonomous systems (e.g., robots and drones), to deliver specific payloads to mitigate land, air and sea events or targets of interest for both military and non-military applications. The fused sensor data is transmitted via wired or wireless communication to an edge AI server for intelligence analysis. The edge AI server communicates fused data (e.g., sensor data and additional analysis) to a cloud-based system for long-term data storage and further historical and pattern-based analysis. A MultiModal Large Language Model (MLLM) is employed to generate situational assessments, incident reports, and incident assistant based on real-time sensor data, mitigation measures, and after-action reviews on the cloud.

### CROSS-REFERENCE TO RELATED APPLICATION(S)

This application claims the benefit of U.S. Provisional Patent Application Ser. No. 63/752,477, filed Jan. 31, 2025, and titled “Systems for And Methods of Edge AI Sensor Fusion to Detect and Respond to Incidents Of Interest,” which is hereby incorporated by reference in its entirety for all purposes.

### FIELD OF THE INVENTION

The present invention relates to the field of sensors. More specifically, the present invention relates to edge Artificial Intelligence (AI) sensors.

### BACKGROUND OF THE INVENTION

In many real-world scenarios, first responders entering hazardous environments must rapidly develop real-time situational awareness to ensure their safety and effectiveness. Although various types of sensors, such as video, acoustic, chemical, and other specialized sensors, are readily available, these sensors are not typically integrated into a cohesive system. Specifically, there is a lack of a unified geospatial 3D map that fuses data from these sensors to provide a comprehensive understanding of the security situation. Furthermore, this critical information is often unavailable to command staff supporting the first responders, limiting their ability to provide timely and informed guidance. As a result, both first responders and command staff face challenges in quickly assessing and responding to hazardous conditions.

### SUMMARY OF THE INVENTION

In the present disclosure, “see, hear, smell” edge AI sensors comprising video, acoustic, and chemical sensors, are integrated with either proprietary or non-proprietary embedded System-on-Module (SoM) or System-on-Chip (SoC) chipsets. These SoM or SoC chipsets analyze and process the sensor data directly, minimizing the computational and battery power requirements. This architecture reduces dependence on external devices, such as smart phones or mobile computing systems, for data processing. Upon detecting an incident (e.g., objects, behaviors, events or targets of interest), edge AI triggers the alerts, notifies relevant parties, and dispatches either human operators or autonomous systems (e.g., robots and drones) to deliver specific payloads. These payloads mitigate land, air and sea events or targets of interest for both military and non-military applications. In addition, the fused sensor data is transmitted via wired or wireless communication to a cloud-based system for long-term data storage and further historical and pattern-based analysis. A Multi-modal Large Language Model (MLLM) will be employed to generate situational assessments, incident reports, and incident assistant-based on real-time sensor data, mitigation measures, and after-action reviews.

The edge AI sensors comprise front and back, or 360-degree video sensors that are trained to detect “objects of interest,” “behaviors of interest,” “events of interest,” or “targets of interest.” The edge AI sensors then generate alerts along with their geospatial location, which is then transmitted to either human operators or autonomous systems (e.g., robots and drones) to deliver specific payload types to mitigate land, air and sea objects, behaviors, events or targets of interest for military and non-military applications.

The application of the present disclosure includes methods of and systems for the fusion of body worn, mobile, portable and stationary edge AI “see, hear and smell” sensors (e.g., chemical sensors for detecting chemical leaking) to detect objects, behaviors, events or targets of interest. Upon detection, edge AI triggers the alerts. It sends a notification to related parties such as a monitoring center, while it dispatches human operators or autonomous systems (e.g., robots and drones) to deliver specific payload types to mitigate land, air and sea objects, behaviors, events or targets of interest for military and non-military applications. In addition, edge AI sends all sensor data such as images, videos, sounds, chemical signatures, geospatial location, and more to a cloud server for further analysis.

The application of the present disclosure includes methods of triggering alerts using: (1) body worn, mobile, portable and stationary edge AI sensor devices integrated with any combinations of video (see), acoustic (hear), chemical (smell) sensors to trigger alerts; (2) body worn, mobile, portable and stationary edge AI sensor devices integrated with any combinations of video (see), acoustic (hear), chemical (smell) sensors, such that when alerts are triggered, instructions are sent to either human operators or autonomous robot and drone response systems to deliver specific payload types to mitigate land, air and sea objects, behaviors, events or targets of interest for military and non-military applications. Further, the application of the present disclosure includes a method (3), where the video sensor includes an edge AI front view and rear-view or 360 degrees view, low power, high resolution video sensor in combination with an acoustic and/or chemical sensor. Further, the application of the present disclosure includes a method (4) using i) a sensor payload ii) a response payload and/or iii) a drone and robot platform.

In some embodiments, upon detecting a gas leak from a pipeline, storage facility, valve station, or elsewhere the edge AI triggers an alert and dispatches a robot or drone. The vehicle is equipped with a marking payload (e.g., a paintball-style projectile containing visible dye or UV-reactive ink). Upon arrival at the leak site, the vehicle fires or applies the marking substance directly onto the compromised area. This approach allows maintenance personnel to swiftly and accurately identify the specific source of leakage, even in large or complex infrastructures where pinpointing the leak could otherwise be challenging. The marking remains visible under normal or ultraviolet light, ensuring that subsequent manual repairs or inspections can be executed with minimal confusion.

In some embodiments, when the system's fused sensor data indicates a chemical spill or hazardous material release, the edge AI triggers the alert and dispatches a drone or robot outfitted with a spray sealant payload. This payload is a quick-setting compound—such as an industrial foam or polymer—that is dispensed onto the leak site to temporarily contain and seal the leak. By reducing or halting further leakage, this measure mitigates environmental harm and improves safety conditions until a permanent repair can be performed. The autonomy provided by the edge AI is particularly advantageous when dealing with corrosive or toxic chemicals, as it minimizes human exposure by automating the sealing process.

In some embodiments, for certain agricultural or ranching scenarios, this disclosure enables edge AI sensors to detect runaway livestock or potentially dangerous animals (e.g., bulls in a feedlot). Upon confirmation of the location and movement pattern, an autonomous vehicle (robot or drone) carrying a tranquilizer payload is deployed. When it arrives at the target location, the drone or robot safely administers a sedative dose using a tranquilizer projectile. This allows ranchers or animal care personnel to regain control of the situation without placing themselves at risk. The edge AI ensures accurate targeting and real-time tracking of the animal's behavior, contributing to more humane and efficient livestock management.

In some embodiments, the system is tailored for law enforcement or security operations, the edge AI detects unauthorized activity or intrusion within a restricted pipeline area. Once the incident is verified, a drone equipped with a GPS tracker payload is dispatched. The drone can launch a small adhesive projectile that attaches to a fleeing suspect's vehicle or other moving object. By discretely tagging the target, security personnel or law enforcement agencies gain real-time location data without pursuing the suspect directly. This reduces risks to officers and innocent bystanders, while maintaining effective surveillance capabilities.

In some embodiments for search and rescue applications, the edge AI identifies an emergency through acoustic signals (e.g., calls for help), thermal readings (e.g., detecting body heat), or distress beacons in a disaster-stricken region. The system dispatches a drone or robot carrying emergency and survival supplies—such as water packets, first-aid kits, or emergency communication devices. The payload is then delivered to survivors at a specific GPS coordinate, helping sustain them until rescue teams arrive. This embodiment showcases the system's utility in remote or inaccessible terrains, where immediate human intervention may be delayed by hazardous conditions or destroyed infrastructure.

In some embodiment, the video and thermal and video sensors identify early signs of a fire outbreak—for instance, detecting smoke plumes, abnormal heat signatures, or elevated temperature readings. The edge AI immediately notifies a firefighting drone loaded with a fire-retardant payload (e.g., chemical foam or suppressant). Upon deployment, the drone precisely targets the ignition source, spraying retardant to contain or extinguish the fire before it spreads. This rapid response significantly reduces damage in industrial facilities, remote pipeline routes, and even in wildlife conservation zones where early-stage intervention can protect broader ecosystems.

In some embodiments, the SoM or SoC disclosed herein contains sensor interfaces that are combined with the above-mentioned sensors. These edge AI Sensors hence can generate sensor alerts, and communicate via wireless communications methods such as Bluetooth®, cellular, WIFI, satellite, RF Radio or any other wireless or wired communication methods to communicate with the first responder.

In some embodiments, the edge AI Sensors detect and analyze incidents, patterns or behaviors utilizing AI algorithms. Alerts are triggered and are sent to either a human operator or autonomous robot and drone response systems to deliver specific payload types to mitigate land, air and sea incidents for military and non-military applications. However, the generated sensor alert data can also be sent to the cloud for storage for record keeping, and for further analysis to generate historical pattern or trend analysis.

In some embodiments, the edge AI sensors comprise video, acoustic, chemical sensors including the fusion of “see”, “hear” and “smell” sensing capabilities. The fusion of edge AI sensors can also include other types of physical security sensors including but not limited to motion (such as pressure, accelerometers, and gyroscopic sensors), proximity, pressure, or environmental sensors (such as temperature, humidity, light and air quality sensors), or biomedical, nuclear, biological, or chemical sensors for gas detection. The edge AI sensors can also be incorporated into body worn, mobile, portable and stationary edge AI sensor systems to detect incidents of interest.

In some embodiments, the edge AI processor utilizes AI pattern matching algorithms to generate the sensor alerts, which are then sent wirelessly to either human operator or autonomous drone and/or robotic systems to deliver specific payload types to mitigate land, air and sea incidents for military and non-military applications.

Other features and advantages of the present invention will become apparent after reviewing the detailed description of the embodiments set forth below.

### BRIEF DESCRIPTION OF THE DRAWINGS

Embodiments will now be described by way of examples, with reference to the accompanying drawings which are meant to be exemplary and not limiting. For all figures mentioned herein, like numbered elements refer to like elements throughout.

FIG. 1 illustrates an edge AI sensor fusion and autonomous response system data flow block diagram in accordance with some embodiments.

FIG. 2 illustrates an edge AI processor embedded into “see, hear and smell” body-worn sensor types in accordance with some embodiments.

FIG. 3 illustrates an edge AI “see, hear and smell” headset-mounted sensor in accordance with some embodiments.

FIG. 4 illustrates an edge AI “see, hear and smell” helmet-mounted sensor in accordance with some embodiments.

FIG. 5 illustrates an edge AI “see and hear” Bluetooth® ear piece sensor in accordance with some embodiments.

FIG. 6 illustrates an edge AI acoustic signature detection and classification process in accordance with some embodiments.

FIG. 7 illustrates an edge AI mobile phone-attached chemical sensor in accordance with some embodiments.

FIG. 8 illustrates edge AI “see, hear, smell” sensor and autonomous systems deployment into an oil pipeline in accordance with some embodiments.

FIG. 9 illustrates edge AI components for “see, hear, smell” sensors and autonomous response system in accordance with some embodiments.

FIG. 10 illustrates edge AI “see, hear, smell” sensors on an autonomous drone response system in accordance with some embodiments.

FIG. 11 illustrates edge AI “see, hear, smell” sensors on an autonomous robot response system in accordance with some embodiments.

FIG. 12 illustrates cloud-centric view of edge AI “see, hear, smell” sensors and autonomous response system in accordance with some embodiments.

FIG. 13 illustrates edge AI sensor fusion and response flow diagram in accordance with some embodiments.

FIG. 14A and FIG. 14B illustrate a sample incident situational assessment report in accordance with some embodiments.

FIG. 15A, FIG. 15B, FIG. 15C illustrate a sample incident report in accordance with some embodiments.

FIG. 16 illustrates an incident assistant flow diagram in accordance with some embodiments.

FIG. 17 illustrates a diagram of a sensor device according to some embodiments.

FIG. 18 illustrates a side view of a system for deployment of the sensor devices and edge AI server for monitoring according to some embodiments.

FIG. 19 illustrates a top view of a system for deployment of the sensor devices and edge AI server for monitoring according to some embodiments.

FIG. 20 illustrates a diagram of a system-on-module according to some embodiments.

FIG. 21 illustrates views of a sentinel enclosure according to some embodiments.

### DETAILED DESCRIPTION OF THE PREFERRED EMBODIMENT

Reference is made in detail to the embodiments of the present invention, examples of which are illustrated in the accompanying drawings. While the invention is described in conjunction with the embodiments below, it is understood that they are not intended to limit the invention to these embodiments and examples. On the contrary, the invention is intended to cover alternatives, modifications and equivalents, which can be included within the spirit and scope of the invention as defined by the appended claims. Furthermore, in the following detailed description of the present invention, numerous specific details are set forth to more fully illustrate the present invention. However, it is apparent to one of ordinary skills in the prior art having the benefit of this disclosure that the present invention can be practiced without these specific details. In other instances, well-known methods and procedures, components and processes have not been described in detail so as not to unnecessarily obscure aspects of the present invention. It is, of course, appreciated that in the development of any such actual implementation, numerous implementation-specific decisions must be made in order to achieve the developer's specific goals, such as compliance with application and business-related constraints, and that these specific goals vary from one implementation to another and from one developer to another. Moreover, it is appreciated that such a development effort can be complex and time-consuming but is nevertheless a routine undertaking of engineering for those of ordinary skill in the art having the benefit of this disclosure.

In some aspect, edge AI sensors that can “see” with video/imaging sensors/devices, “hear” with acoustic sensors/device and “smell” with chemical sensors/devices that are embedded with either non-proprietary or proprietary high performance, low power or low “energy” edge computing SoM or edge AI chipsets, which includes a SoC or a custom designed Application-Specific Integrated Circuit (ASIC) that meets a unique range of wearable edge AI chipset performance requirements in terms of TOPS (Tera Operations Per Second) and power efficiency requirements, and sensor location is GPS tracked via a GPS sensor embedded with the SoM or SoC.

In some embodiments, the edge AI Sensors detect objects, behaviors, events or targets of interest which then generate alerts utilizing pattern matching AI algorithms. The detected alert data is then processed by the edge AI processor embedded in SoM or SoC chipsets, which does not utilize communications to the Cloud or a Central Processing Unit (CPU) external to the sensor. However, the generated security threat alert data can be sent to the cloud for storage for record keeping, and for further analysis to generate historical pattern or trend analysis.

In some embodiments, the edge AI pattern matching algorithms generate the detected alert data and sends the alerts wired or wirelessly, which then sends the alerts to a human operator, or autonomous drone and/or robotic systems. Then, the course of action is determined to be taken by executing specific patrol patterns and delivering a specific type of payload package on the drone or robot.

In some embodiments, a human operator response can be as simple as instructing personnel to further investigate the objects, behaviors, events or targets of interest, and a payload type can be the human operator using a fire extinguisher to extinguish a potential fire hazard. An autonomous robot response on land can be the edge AI Sensor System sending an alert to a robot vehicle to perform a specific patrol pattern to investigate objects, behaviors, events or targets of interest, and the payload type can be the robot vehicle sending a verbal warning to an intruder.

In some embodiments, an autonomous drone response on sea can be the edge AI sensor system sending an alert to a drone vessel to perform a specific patrol pattern to investigate objects, behaviors, events or targets of interest at sea, and the payload type can be the robot vessel continuing to follow its target(s) of interest and sending a warning to the target.

In some embodiments, an autonomous drone response in air can be the edge AI sensor system sending an alert to a drone to perform a specific patrol pattern to investigate objects, behaviors, events or targets of interest, and the payload type can be the drone shooting a paint ball pellet at the location of a chemical leak to help repair personnel to easily identify the exact location of the leak.

In some embodiments, in addition to alerts sent to a human operator or robot or drone operation system, an autonomous command/action is directly sent to a local device or relative party by an edge AI device upon detecting an urgent or well-define targeted objective/event, to perform an urgent, direct and/or specific action. An example of such an event can be a fire or explosion that happens at a gas pipeline; edge AI can send out a command to shut off a local upstream valve. A human operator, robot or drone will further investigate the objects, behaviors, events or targets of interest, and take further and necessary payload action.

In some embodiments, an edge AI device is a hardware system designed to perform Artificial Intelligence (AI) computations directly on the device itself, rather than using centralized cloud-based servers for processing. These devices integrate both AI capabilities and edge computing principles, enabling real-time data processing and decision-making at the source where data is generated. The key characteristics of edge AI devices include: 1) local processing: they execute AI algorithms locally, minimizing the need for data transmission to the cloud; 2) low latency: by processing data on-site, they provide faster response times, which is important for real-time applications; 3) data privacy: sensitive data is processed locally, reducing the risk of breaches and enhancing privacy; 4) offline capability: many edge AI devices can operate without continuous Internet connectivity; and 5) energy efficiency: designed to perform complex computations with optimized power usage, often running on limited resources.

In some embodiments, examples of edge AI devices include smartphones with built-in AI processors for facial recognition, image enhancement, and virtual assistants; Internet of Things (IoT) devices such as smart cameras for surveillance or smart speakers with voice recognition; wearable devices such as health monitoring rings, smartwatches, and fitness trackers; autonomous machines such as drones, robots, and self-driving cars that perform real-time decision-making; and industrial equipment in smart factories for quality control, predictive maintenance, and automation. Edge AI devices are important in applications performing real-time insights, efficient data handling, and reduced reliance on high-bandwidth internet connections.

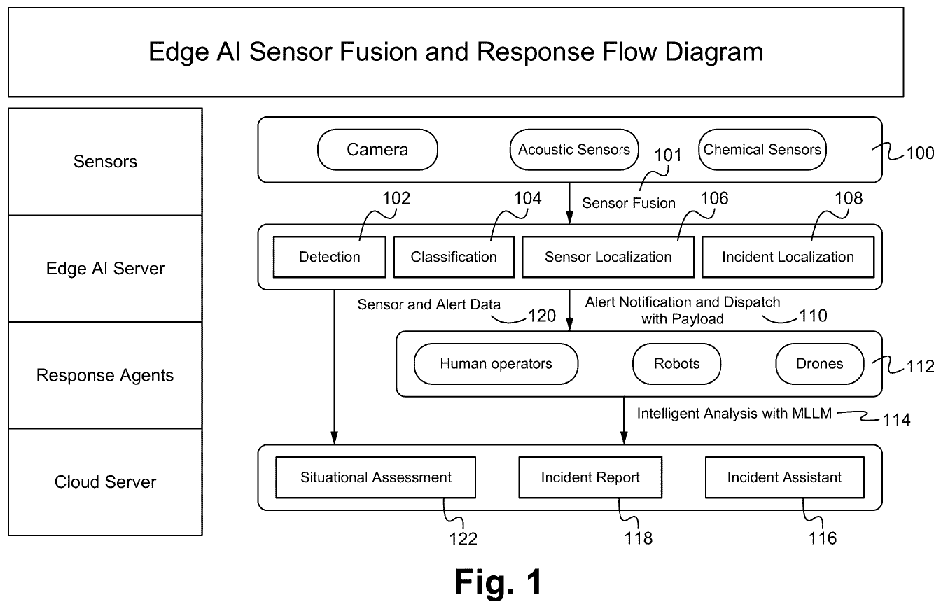

FIG. 1 illustrates an edge AI sensor fusion and autonomous response system data flow block diagram in accordance with some embodiments. Various sensors 100 are able to be implemented such as cameras, acoustic sensors and/or chemical sensors. The sensor information is able to be combined/fused 101 in any manner.

The system (e.g., a server implementing AI) detects 102 an incident within the fused sensor information. The system (e.g., via AI) classifies 104 the incident into one or more classifications. For example, an incident is classified as a leak, fire, explosion, intrusion, and/or any other classification. In some embodiments, the classifications are broader and/or sub-classifications are implemented. For example, incidents that require immediate action (e.g., leak, explosion, fire) are classified as emergencies, and other incidents are classified as non-emergencies. The system (e.g., via AI) performs sensor localization 106 which indicates which sensor or sensors have detected an incident. The sensor localization 106 is able to be implemented in any manner such as each sensor or device including current location information and timestamp information with each communication/transmission of information. Based on the sensor localization 106, the system (e.g., via AI) performs incident localization 112 such that the specific location of the incident is determined (e.g., via a tracking device or marking device).

Based on the analysis, an alert notification is sent 110 to one or more response agents (e.g., human operators, robots, drones). The response agents are able to perform actions based on the alert notification. For example, the response agents are able to put out a fire, seal a leak, evacuate an area, or take any other action). The alert notification (including dispatching one or more response drones, robots, robot dogs, or humans) is able to be triggered and sent by the edge AI server and/or a cloud server device. Intelligent analysis 114 is able to be performed using the response agents and communicated to a cloud server device.

Based on the analysis, sensor and alert data are sent 120 to the cloud server device. The cloud server is able to perform a situational assessment 122, generate an incident report 118, and/or provide an incident assistant 116.

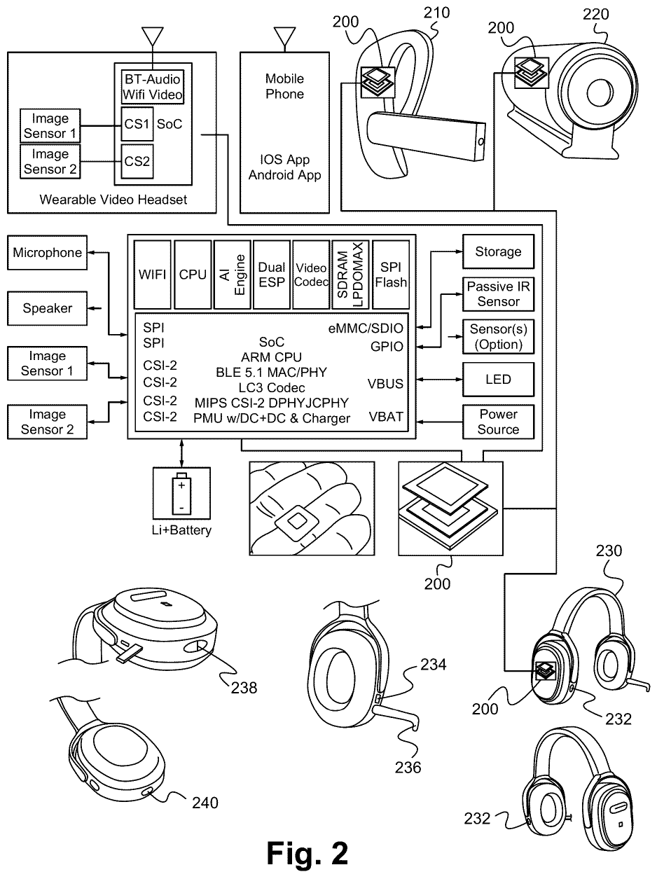

FIG. 2 illustrates an edge AI processor embedded into “see, hear and smell” body-worn sensor types in accordance with some embodiments. An edge AI processor 200 is implemented as described herein such as including one or more sensors. The edge AI processor 200 is able to be included in a Bluetooth® ear piece 210. The edge AI processor 200 is able to be included in a helmet-mounted device 220. The edge AI processor 200 is able to be included in a headset 230. The headset 230 is able to include front and rear cameras 232, a USB-C port 234, a microphone extension 236, play/volume buttons 238, a power button 240, and/or other features.

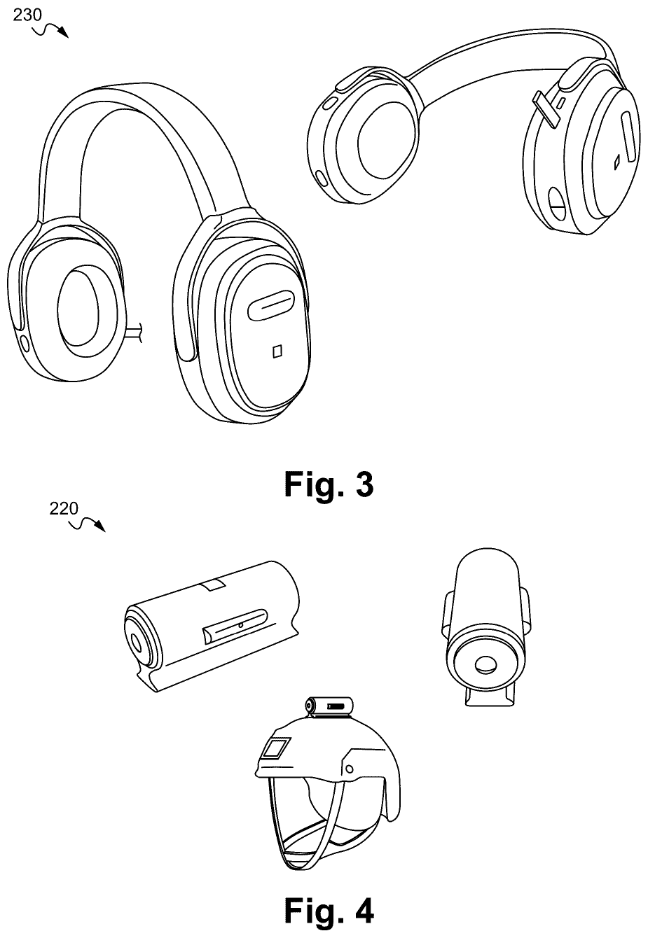

FIG. 3 illustrates an edge AI “see, hear and smell” headset-mounted sensor in accordance with some embodiments. The headset 230 includes an edge AI processor 200, and components of the headset 230 are able to be used to acquire images/videos, audio and/or chemical information using various sensors/devices in/on the headset 230 in conjunction with the edge AI processor 200.

FIG. 4 illustrates an edge AI “see, hear and smell” helmet-mounted sensor in accordance with some embodiments. The helmet-mounted device 220 includes an edge AI processor 200, and components of the helmet-mounted device 220 are able to be used to acquire images/videos, audio and/or chemical information using various sensors/devices in/on the helmet-mounted device 220 in conjunction with the edge AI processor 200.

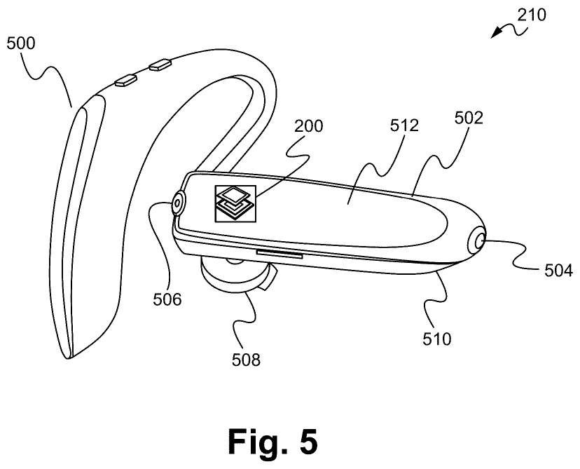

FIG. 5 illustrates an edge AI “see and hear” Bluetooth® ear piece sensor in accordance with some embodiments. The earpiece 210 includes the edge AI processor 200, a behind-the-ear gateway 500, sensors 502, a front camera 504, a rear camera 506, a speaker 508, a microphone 510, and a shell/casing/cover 512. The behind-the-ear gateway 500 is able to include an AI chip or module, Bluetooth® radio, battery, microSD card, USB-C charging, and other devices. The sensors 502 are able to include an accelerometer, a g-force sensor, a pressure sensor, and a capacitive touch sensor. The front camera 504 and the rear camera 506 are able to be any cameras (e.g., 1080 p, 4K, 8K). The speaker 508 is able to be any speaker such as an ear gel speaker. The microphone 510 is able to be any microphone such as a noise-canceling microphone. The shell 512 is able to be any shell such as an IPX4 water resistant shell.

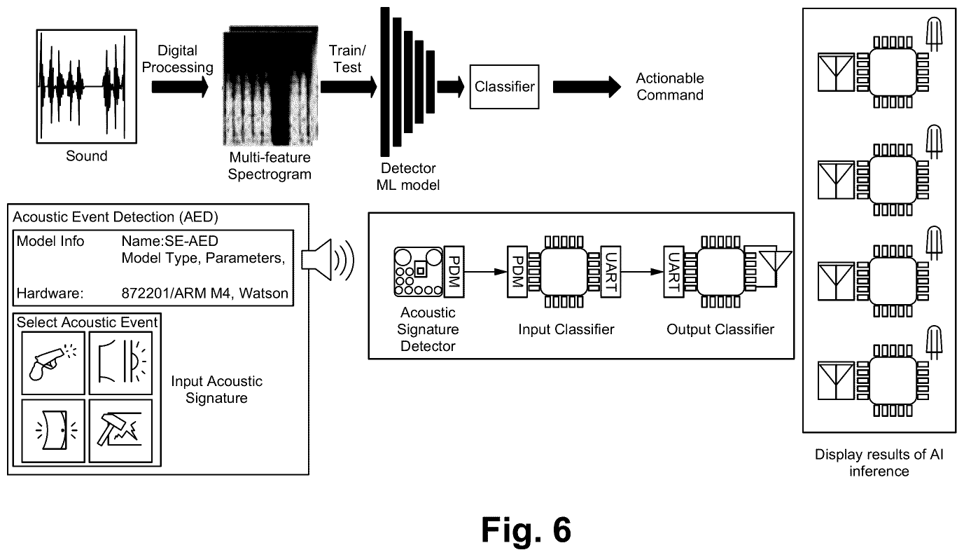

FIG. 6 illustrates an edge AI acoustic signature detection and classification process in accordance with some embodiments. The acoustic signature detection and classification process is able to be implemented in any manner such as receiving a sound, performing digital signal processing, training and testing a machine learning detector model which generates a classifier, and generating an actionable command.

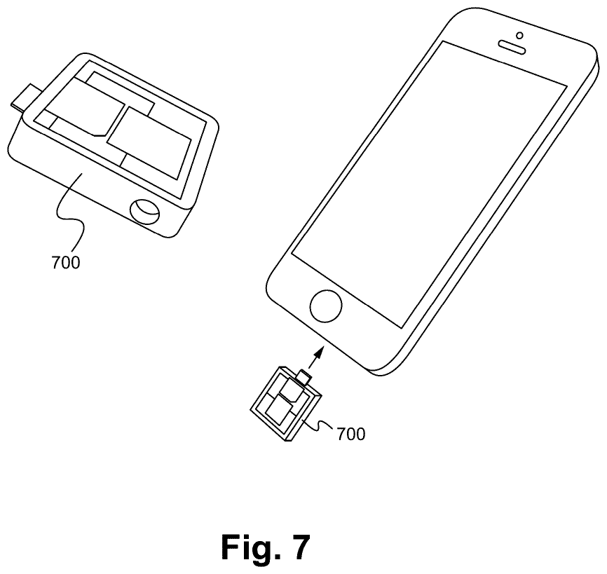

FIG. 7 illustrates an edge AI mobile phone-attached chemical sensor in accordance with some embodiments. The chemical sensor 700 is able to be any chemical sensor configured to detect any chemicals. For example, the chemical sensor 700 is configured to detect hazardous gases and environmental pollutants. The chemical sensor 700 is able to be a nano-chemical sensor, a micro-chemical sensor, or any other chemical sensor.

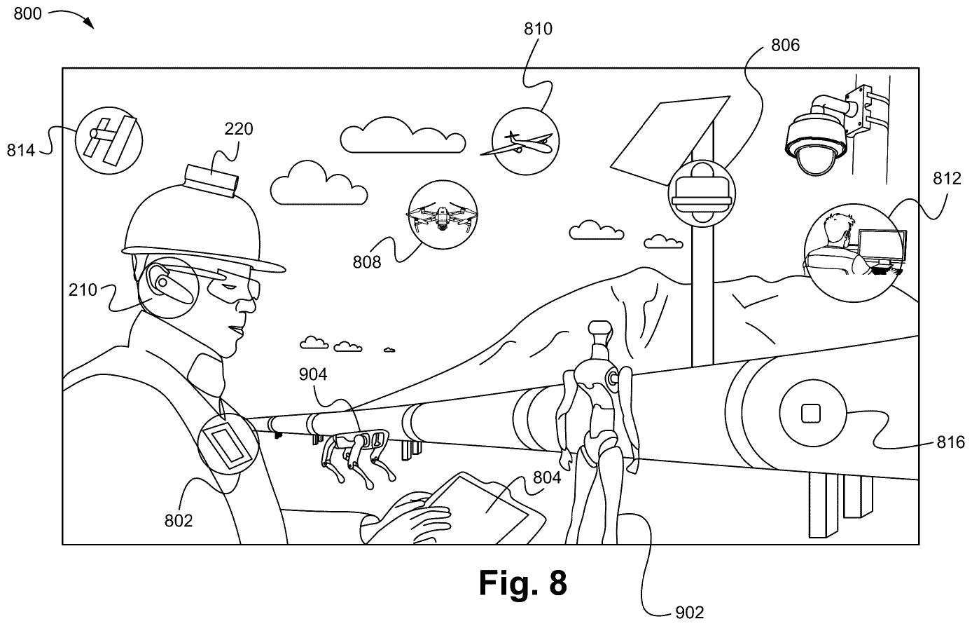

FIG. 8 illustrates edge AI “see, hear, smell” sensor and autonomous response systems deployment into an oil pipeline in accordance with some embodiments. The oil pipeline system 800 is able to employ many aspects of the edge AI sensors. For example, an acoustics and chemical sensor 816 is able to be incorporated on/in an oil pipeline. The acoustics and chemical sensor 816 is able to perform any form of detection. For example, the acoustics and chemical sensor 816 is able to detect the oil flow, and if the flow drops below a threshold, that information is transmitted. In another example, the acoustics and chemical sensor 816 is able to detect pressure within the pipe, and if the pressure rises above a threshold, then that information is transmitted. In yet other examples, the acoustics and chemical sensor 816 is able to detect a sound (e.g., explosion), smoke, a temperature above a threshold, gas vapors and/or any other information to indicate a potential issue.

A user (e.g., worker) is able to wear a helmet-mounted device 220, an ear piece 210 and/or a wearable chemical sensor 802. The wearable chemical sensor 802 is able to detect concentrations of specific gases such as natural gas, CO, and/or any other gases or toxic fumes. As described, these devices are able to acquire audio, video, and/or other information. In some embodiments, the wearable chemical sensor 802 is able to include any input acquisition components such as a camera, a microphone and/or any other sensors. The user is also able to review any of the information acquired from any of the sensors on a mobile device 804 (e.g., tablet, smart phone).

A camera 806 is able to be positioned to monitor the pipeline and surrounding area. For example, the camera 806 includes one or more edge AI processors/sensors. The camera 806 is then able to detect potential issues such as a fire in or near the pipeline, unauthorized people/animals near the pipeline, a leak from the pipeline, and/or any other potential issues. The camera 806 is able to communicate any acquired information. For example, the camera 806 communicates information regarding a pipeline leak to an operator 812 who is then able to communicate with another person (e.g., a worker) via the mobile device 804. In some embodiments, the mobile device 804 is a sensor fusion application pad. In some embodiments, communications occur through a satellite system 814. In some embodiments, the satellite system 814 is able to be used to acquire information (e.g., a satellite is able to be used to determine the size and/or location of a fire).

One or more drones 808 and one or more Unmanned Aerial Vehicles (UAVs) 810 are able to be utilized as described herein. For example, the drones 808 and UAVs 810 are able to be used for monitoring purposes to detect leaks, fires, smoke, explosions, unauthorized guests, and more. The drones 808 are able to perform the monitoring utilizing any devices such as cameras, microphones, and/or sensors. The drones 808 are also able to be used to tag and/or stop potential issues. For example, if a leak is detected, then a drone 808 is able to apply a sealant to temporarily or permanently stop the leak. In another example, the drone 808 is able to apply a tracking device or paint to aid workers in finding the exact location of the leak. In some embodiments, the drone provides the current GPS location to a worker or operator to aid in locating the leak. The drones 808 are able to communicate any information. For example, if the drones 808 detect a leak, fire, and/or other potential issues, then specific information is able to be transmitted (e.g., to an operator 812 or a worker's mobile device 804 via a satellite 814 or any other means of communication). The information transmitted is able to include an alert/issue code, current location information, and/or more detailed information such as approximate dimensions of the size of the fire, a video of the fire and/or audio of an explosion.

A robot 902 and/or a robot dog 904 are able to be included with the system. The robot 902 and the robot dog 904 are able to perform the functions described herein such as performing additional monitoring and being deployed to address an issue. For example, if there is a leak, the robot 902 and/or robot dog 904 are triggered and respond to seal the leak with a sealing substance or extinguish a fire by applying a fire retardant. The robot 902 and the robot dog 904 are able to include a sensor device with see, hear and smell sensors and/or other sensors.

Although the components have been described as having specific features, any of the components are able to be modified to include fewer or additional features. For example, the helmet-mounted device 220 is able to include a mechanism to acquire acoustic information and a sensor to acquire chemical information.

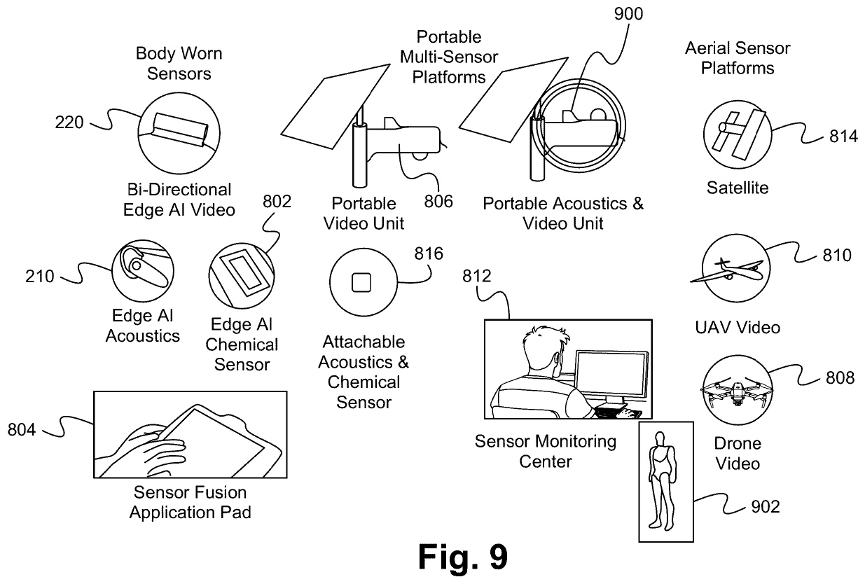

FIG. 9 illustrates edge AI components for “see, hear, smell” sensors and autonomous response system in accordance with some embodiments. As described, many edge AI components are able to be utilized to monitor and respond to a variety of situations. The edge AI components are able to include body worn sensors such as a helmet-mounted device 220 to acquire bi-directional video, an earpiece 210 to acquire acoustics, and a wearable chemical sensor 802 to detect gas-related data such as concentrations above a threshold.

A mobile device 804 such as a sensor fusion application pad is able to be used to send and receive information. The mobile device 804 includes a display configured for displaying information received from one or more of the edge AI components. In some embodiments, the mobile device 804 includes detection mechanisms.

Multi-sensor platforms are able to be used to acquire information such as a camera 806 (e.g., a portable video unit), an AV camera 900 (e.g., a portable acoustics and video unit), and an attachable acoustics and chemical sensor 816. A sensor monitoring center is able to be utilized by an operator 812 to monitor the various information received from the edge AI components.

Aerial sensor platforms are able to include one or more satellites 814, UAVs 810 and drones 808. The satellites 814 are able to take satellite images or videos. The UAVs 810 are able to acquire images, videos and/or audio. The drones 808 are able to acquire images, videos and/or audio.

Robot sensors 902 are also able to be utilized. The robot sensors 902 are able to be autonomous. The robot sensors 902 are able to acquire images, videos and/or audio.

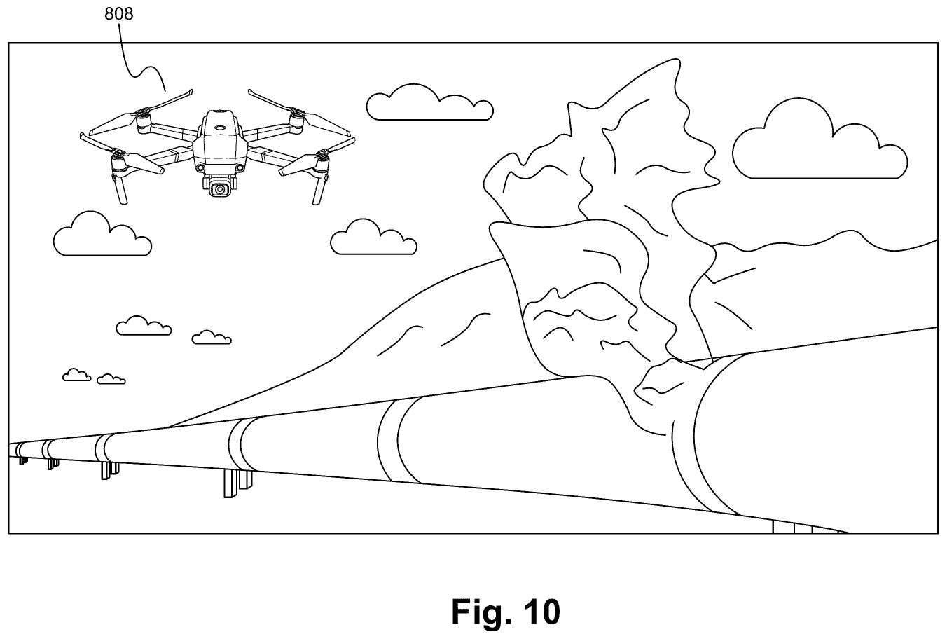

FIG. 10 illustrates edge AI “see, hear, smell” sensors on an autonomous drone response system in accordance with some embodiments. As described, an autonomous drone 808 is able to include various sensors such as one or more cameras, one or more microphones, and/or one or more other sensors (e.g., chemical sensors, smoke sensors, temperature sensors) to acquire information. For example, the autonomous drone 808 is able to detect an explosion and/or fire using the microphone (audio detection), the camera (visual detection) and/or the one or more additional sensors (e.g., a thermometer to detect excessive heat, a smoke detector to detect smoke, a chemical sensor to detect toxic chemicals). The autonomous drone 808 is able to respond to an emergency (e.g., explosion, leak, fire), in any manner described herein such as by deploying a sealant to seal a crack/fissure, marking a leak with a trackable device or paint, applying a fire retardant, and/or sending location coordinates to a response team.

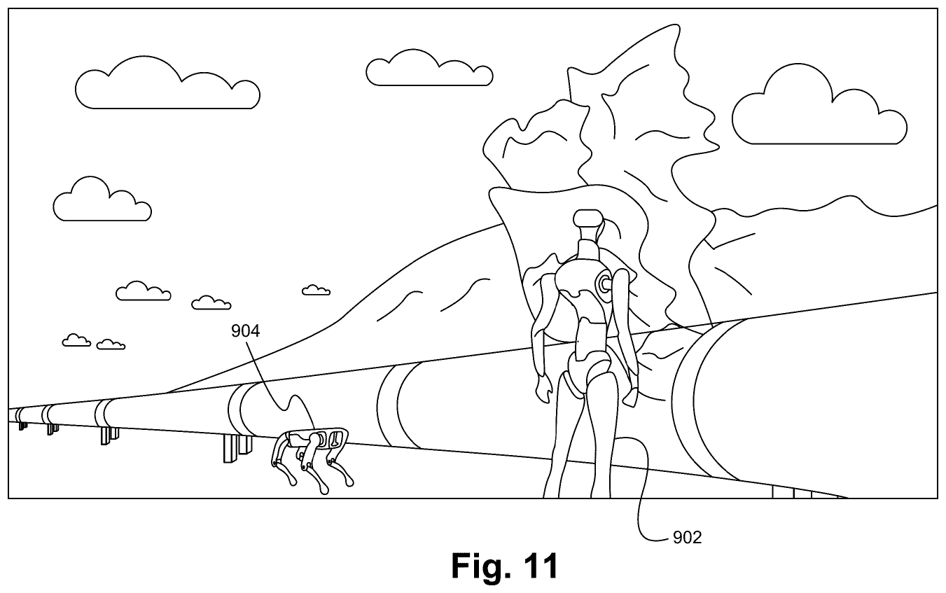

FIG. 11 illustrates edge AI “see, hear, smell” sensors on an autonomous robot response system in accordance with some embodiments. The autonomous robot 902 is able to be any autonomous robot in terms of appearance, functionality and capabilities. The autonomous robot 902 is able to include various sensors such as one or more cameras, one or more microphones, and/or one or more other sensors (e.g., chemical sensors, smoke sensors, temperature sensors) to acquire information. For example, the autonomous robot 902 is able to detect an explosion and/or fire using the microphone (audio detection), the camera (visual detection) and/or the one or more additional sensors (e.g., a thermometer to detect excessive heat, a smoke detector to detect smoke, a chemical sensor to detect toxic chemicals). The autonomous robot 902 is able to respond to an emergency (e.g., explosion, leak, fire), in any manner described herein such as by deploying a sealant to seal a crack/fissure, marking a leak with a trackable device or paint, applying a fire retardant, and/or sending location coordinates to a response team. The autonomous robot 902 is able to be deployed in a situation that may be dangerous to humans (e.g., an out of control fire, an imminent explosion, a toxic leak). In some embodiments, the robot 902 is not autonomous (e.g., remote controlled by a human operator).

An autonomous robot dog 904 is able to perform any of the tasks/functions the autonomous robot 902 performs and is able to have any of the features of the autonomous robot 902. For example, the autonomous robot dog 904 includes a sensor device (see, hear, smell sensors) to detect acoustic or chemical issues and take pictures of an event/issue. The autonomous robot dog 904 is able to include repair capabilities (e.g., a sealant), marking capabilities (e.g., paint) and/or other capabilities described herein. In some embodiments, the autonomous robot dog 904 has different capabilities from the autonomous robot 902 such as being able to run/move more quickly, being more stable, and/or including features that are not included in the autonomous robot 902. In some embodiments, the autonomous robot 902 and autonomous robot dog 904 work together to perform tasks. For example, the autonomous robot 902 stores and deploys one part of an epoxy for sealing cracks, and the autonomous robot dog 904 stores and deploys a second part of the epoxy, where when the two epoxy parts are deployed and mixed together, they harden to seal the crack. In some embodiments, the robot dog 904 is not autonomous (e.g., remote controlled by a human operator).

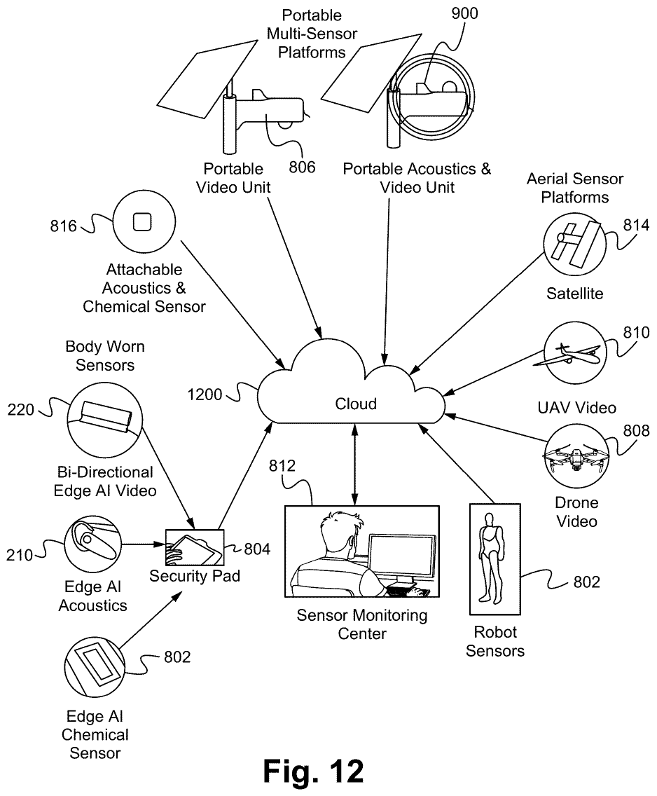

FIG. 12 illustrates cloud-centric view of edge AI “see, hear, smell” sensors and autonomous response system in accordance with some embodiments. As described, the system is able to include body worn sensors such as a helmet-mounted device 220, an earpiece 210, and a wearable chemical sensor 802. The system also includes a mobile device 804 such as a sensor fusion application pad.

The system includes multi-sensor platforms such as a camera 806 (e.g., a portable video unit), an AV camera 900 (e.g., a portable acoustics and video unit), and an attachable acoustics and chemical sensor 816. The system includes a sensor monitoring center which is utilized by an operator 812.

The system also includes aerial sensor platforms including one or more satellites 814, UAVs 710 and drones 808. The system includes robot sensors 902.

All of these devices/components/aspects are able to communicate with a cloud device/system 1200. For example, some devices acquire information and send the information to the cloud device/system 1200 for processing/analysis. Furthering the example, a chemical sensor 802 sends gas readings to the cloud device/system 1200. Some devices receive instructions from the cloud device/system 1200. For example, a drone 808 receives instructions from the cloud device/system 1200 to monitor an area. Some devices send and receive information to and from the cloud device/system 1200. For example, robot sensors 902 are able to monitor an area and send readings to the cloud device/system 1200, and the robot sensors 902 also receive instructions to take actions based on the cloud device/system 1200 processing the readings. Any other communications are able to be performed between any of the devices and/or the cloud device/system 1200. The cloud device/system 1200 is able to receive information, process information, send information, and/or perform additional tasks. In some embodiments, the cloud device/system 1200 implements AI/ML and/or other autonomous/learning techniques to process the information received and/or send instructions.

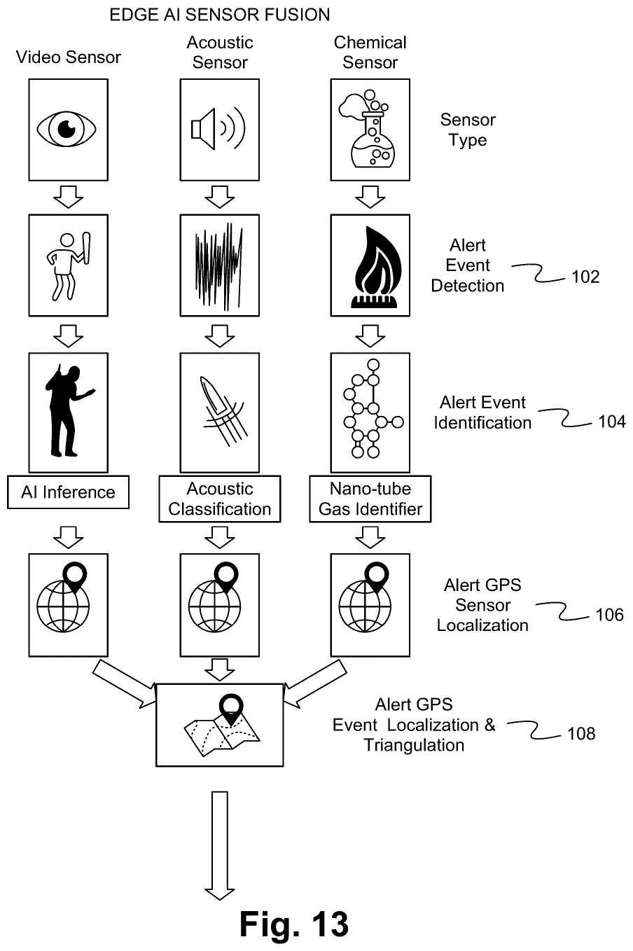

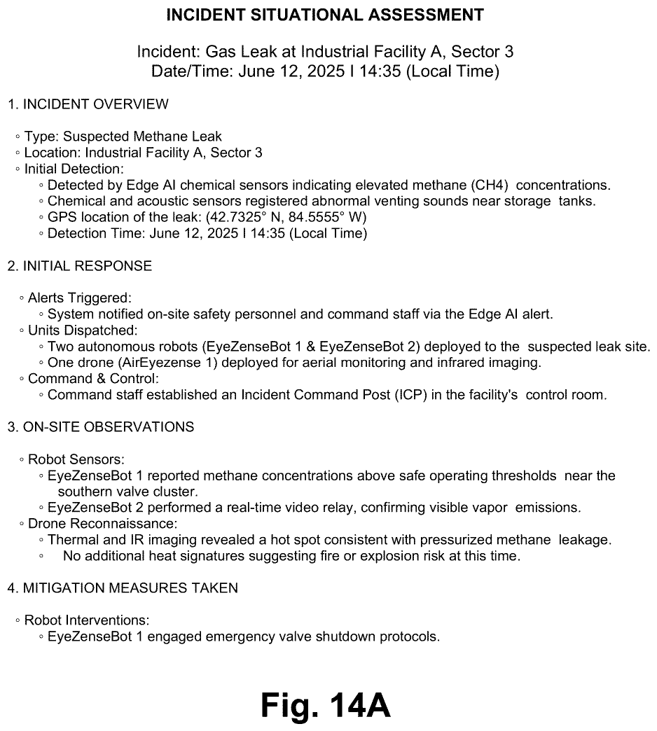

FIG. 13 illustrates edge AI sensor fusion and response flow diagram in accordance with some embodiments. Upon incident detection from the fused sensor data, edge AI triggers the alerts and dispatches human operators, or autonomous systems (e.g., robots and drones), to deliver specific payloads to mitigate land, air and sea events or targets of interest for both military and non-military applications. In addition, the fused sensor data is transmitted via wired or wireless communication to a cloud-based system for long-term data storage and further historical and pattern-based analysis. A MultiModal Large Language Model (MLLM) will be employed to generate situational assessments, incident reports, and incident assistant based on real-time sensor data, mitigation measures, and after-action reviews on the cloud.

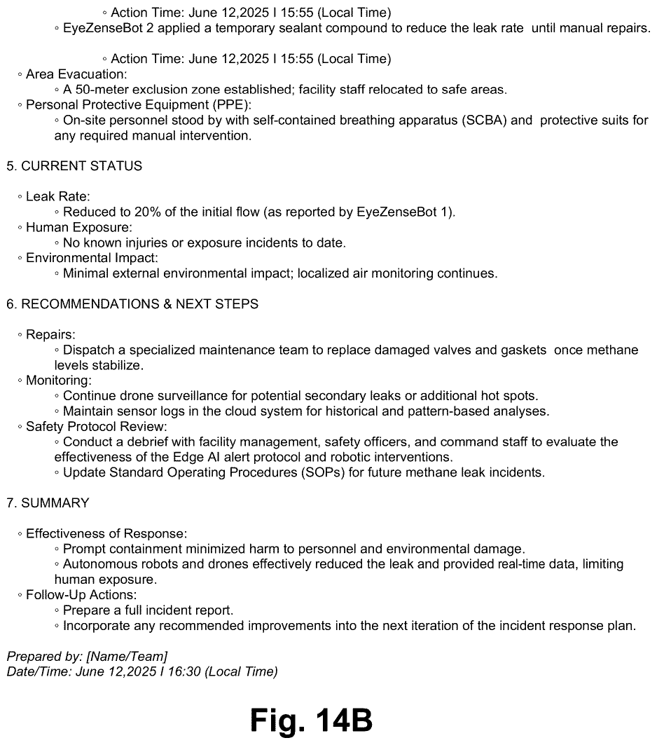

FIG. 14A and FIG. 14B illustrate a sample incident situational assessment report in accordance with some embodiments. The report is generated automatically by Multimodal Large Language Model (MLLM) at preset intervals following the initial detection. The report includes incident overview, initial response, on-site observations, mitigation measures taken, current status, recommendations & next steps, and summary based on real-time sensor data, mitigation measures, and after-action reviews.

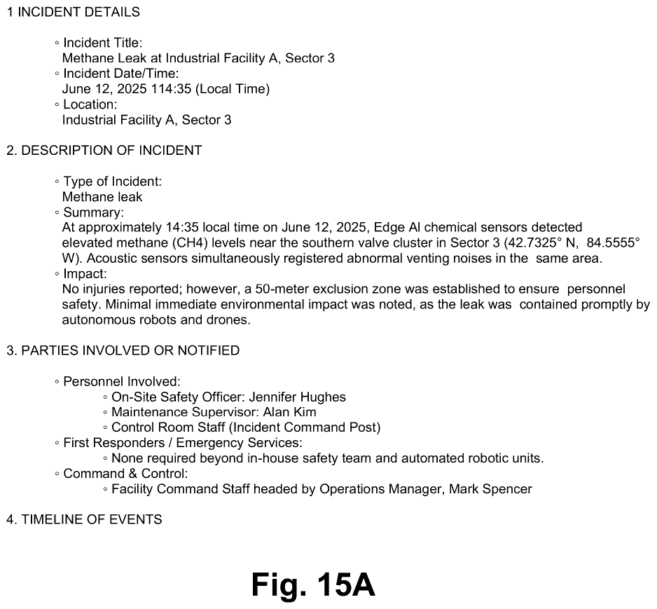

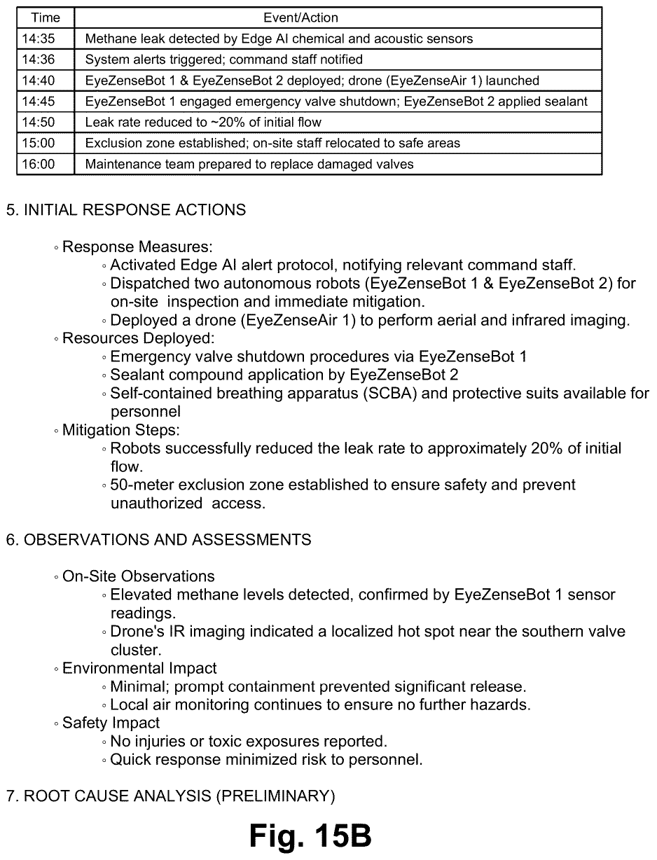

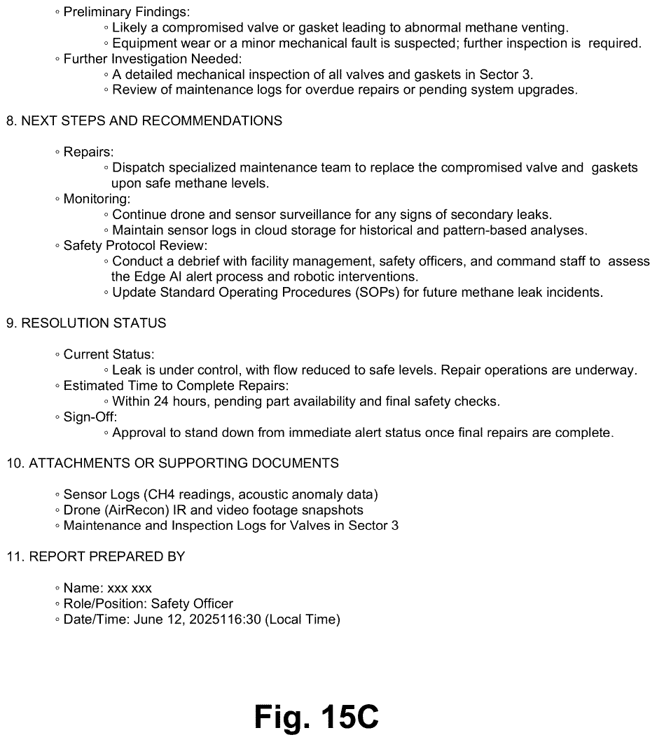

FIG. 15A, FIG. 15B, FIG. 15C illustrate a sample incident report in accordance with some embodiments. The report will be generated by Multimodal Large Language Model (MLLM) following the conclusion of the incident. The report includes incident details, parties involved or notified, timeline of events, initial response actions, observations and assessments, root cause analysis (preliminary), next steps and recommendations, resolution status, attachments or supporting documents based on real-time sensor data, mitigation measures, and after-action reviews.

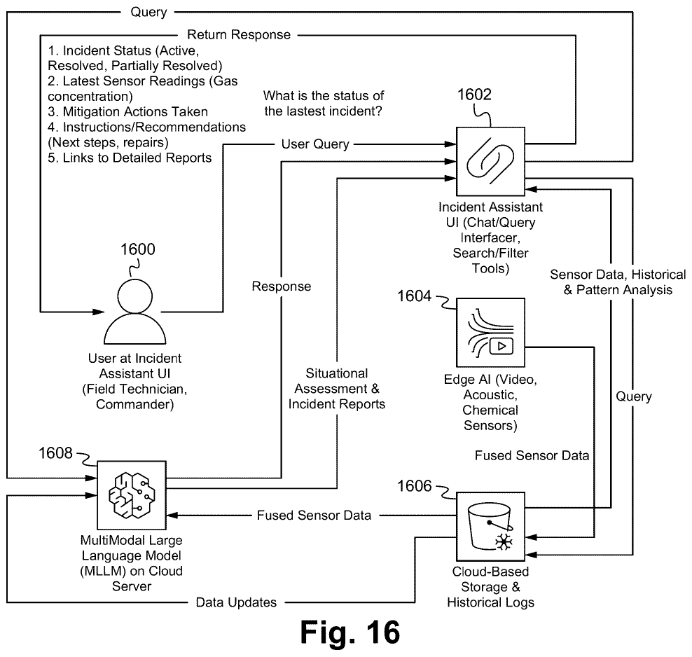

FIG. 16 illustrates an incident assistant flow diagram in accordance with some embodiments. In the workflow, a user 1600 (e.g., a field technician or commander) interacts with the Incident Assistant UI 1602 to ask about an ongoing incident. The Incident Assistant UI 1602 (e.g., a user interface) collects sensor data 1604 (e.g., video, acoustic, chemical) and historical records from the cloud 1606, then routes this information to a MLLM 1608 for analysis and generation of situational assessments and incident reports. The system then returns key information—such as incident status, sensor readings, and recommended actions—back to the user through the Incident Assistant UI 1602.

In utilization, the fusion of edge AI body worn, mobile, portable and stationary edge AI sensors are used to detect objects, behaviors, events or targets of interest.

In operation, the system described herein utilizes see, hear, and smell sensors. These are also referred to as vision sensors (e.g., camera), acoustic sensors (e.g., microphone), and nano/micro chemical sensors (e.g., gas sensors). The see, hear, and smell sensors are able to be included in a single sensor device.

In some embodiments, each sensor device encapsulates all of the sensors (see, hear, smell sensors). In other words, a sensor device includes a vision sensor, an acoustic sensor and a chemical sensor. In some embodiments, the sensor device also includes a SoM or SoC. The sensor device utilizes Wi-Fi (or another communication protocol) and has a power supply (e.g., batteries), a power management system, and a solar cell/panel. In some embodiments, the sensor device is also referred to as a sentinel node.

In some embodiments, the vision sensor of the sensor device only takes pictures upon being triggered by the acoustic sensor and/or the chemical sensor (e.g., when the acoustic sensor or chemical sensor detects something). For example, if the chemical sensor detects there might be a leak, and the acoustic sensor hears a cracking or hissing sound, then the sensor fusion algorithm is run on the device level, and in that node device level, it is indicated that something might be happening. At that time, the camera in the sensor device is triggered and starts taking pictures of the area for forensic evidence. In some embodiments, the data is fused together with the notification or alerts, and together with original data will all be sent to the edge AI server. For example, a hissing sound is detected by the acoustic sensor, a methane trace is detected by the chemical sensor, and a vapor plume is detected in a picture taken by the camera, which collectively confirm that there is a leak. In some embodiments, acquired image(s) are not fused with the acoustic and chemical information.

In some embodiments, the acoustic information, the chemical information and the acquired images are transmitted separately. In some embodiments, the acoustic information and the chemical information are fused together, but the acquired images are not and are sent separately. In some embodiments, the acoustic information, the chemical information and additional information (e.g., environmental information such as temperature or humidity) are fused. Any combination of fusing or merging information together and/or sending additional/separate information is able to be implemented.

In some embodiments, the sensor devices are positioned every meter (e.g., along a pipeline or other structure), although any separation distance is possible (e.g., every 3 meters, 10 meters, or larger distances). Thus, for example, in a 1000 meter pipeline, there may be 1000 sensor devices.

In addition to detecting an event/incident, the sensor device communicates additional information such as environmental data (e.g., humidity, temperature) as well as location information (e.g., GPS coordinates and altitude). Device identification, timestamp information and status information are all able to be communicated from the sensor device to the edge AI server and then to the cloud device which is able to communicate with a security operations center.

An edge AI server is also included in the system. An edge AI server is a local server. For example, a server is local (e.g., near) to the sensor devices such that the server is within Wi-Fi range of a set of the sensor devices. In some embodiments, many edge servers are able to be included. For example, every 120 meters (or a shorter or longer distance), there is an edge AI server configured to communicate with devices (e.g., the sensor devices, cloud devices, other edge AI servers). The sensor devices are able to communicate with the edge AI server via Wi-Fi or another communication protocol. In some embodiments, a sensor device is configured to communicate with a single edge AI server. In some embodiments, if the edge AI server is unavailable, the sensor device communicates with another edge AI server.

The edge AI server includes a vision sensor (e.g., an AI camera). The AI camera is able to perform AI processing and capture/stream video. The edge AI server includes a solar panel and/or another power source (e.g., batteries). The edge AI server is able to include other components/devices as well (e.g., acoustic sensors, chemical sensors, communication devices). The edge AI server performs a second level of data fusion. The edge AI server takes the information from the sensor device node, e.g., all the data from the acoustic sensor and the chemical sensor, metadata, and the first level fused data (e.g., fused sensor data which indicates a detection by the chemical sensor such as a chemical leaking). All the data is fused with the video stream from the edge AI server camera. The data is fused, and there will be one or more alerts. Results, alerts and notifications are sent to the cloud (e.g., one or more cloud devices). In some embodiments, the edge AI server alerts the notification dispatch with the payload. In some embodiments, the edge AI server is able to trigger an alert and dispatch a robot, robot dog, drone or human operator.

In some embodiments, the cloud fuses all of the data from different edge AI servers. The cloud takes in all of the information from different surrounding areas. The cloud then determines whether to dispatch a robot, drone, or human operator. The sensor data goes to the cloud server for situational assessment and incident report generation. The cloud server will alert the notification dispatch with the payload. In some embodiments, the cloud server is able to trigger an alert and dispatch a robot, robot dog, drone or human operator.

In some embodiments, the sensor devices are able to be placed in/on wearable devices. For example, the sensor devices are able to be incorporated in a helmet, an armband, an earpiece, and/or any other wearable or mobile device. The human operator is able to wear a wearable sensor device when responding to an alert.

In some embodiments, robots, drones, UAVs, satellites, and/or other devices include a sensor device (see, hear, smell components). For example, a drone with a sensor device is deployed to a potential leak, and then the sensor device on the drone is able to detect and confirm the leak. Furthering the example, the leak may diffuse more or stop, so by sending a drone to obtain confirmation information, more certainty about the situation is known. The drone is able to continuously monitor the situation as well. Moreover, depending on the situation, the drone is able to move to acquire information while also avoiding being damaged (e.g., from a fire). In another example, some of the drones glide through and take images, such as optical images of the plumes or images of an oil leak. When a human is alerted to respond to an issue (e.g., leak), the human is able to wear a wearable sensor device with see, hear, and smell sensors for further verification purposes as well as safety measures for the human.

The drones and/or robots can also be used for maintenance, such as replacing the batteries if they are damaged or dead. Predictive maintenance is able to be implemented (e.g., to clean the solar panel or replace a battery in a sensor device). Predictive maintenance is able to be implemented based on an amount of current or other measurable data points that indicate a failing device. Similarly, dust or debris on a solar panel may affect the performance of the panel which would indicate the time for cleaning.

In some embodiments, the sensor devices are able to include a magnet attached to a pole which is clamped to a pipe (e.g., oil pipeline).

In some embodiments, the sensor devices are on another device to monitor the device health. For example, a satellite includes a sensor device to detect potential issues with the satellite.

The stationary sensor devices are able to be placed on structures that are above ground, underground, or underwater. The system described herein is able to be used for many purposes such as: monitoring gas, oil, or water pipelines (e.g., detecting leaks and other issues), fire detection (e.g., forest fires) and post-fire hazardous gas detection, home safety alarms (e.g., smoke detection), security and safety screening in environments such as stadiums, mines, closed cargo areas, airports, and similar settings, battlefield applications for soldier protection against chemical and biological threats, medical diagnostics, environmental monitoring, greenhouse gas detection related to global warming, earthquake and volcanic eruption detection, and biological and ecological monitoring of ocean and marine life.

In addition to detecting leaks, fires, and explosions, the sensor devices and/or edge AI servers are able to detect human intruders and are able to trigger alarms such as an alarm sound, turning lights on, and dispatching drones and/or robots to the area. The edge AI server and/or a cloud device generates a post-incident report.

The system described herein is also able to be used for military purposes. For example, soldiers wear wearables to collect data about their surroundings. The data is sent to the cloud along with other data (e.g., images and videos) collected from drones, UAVs and satellites.

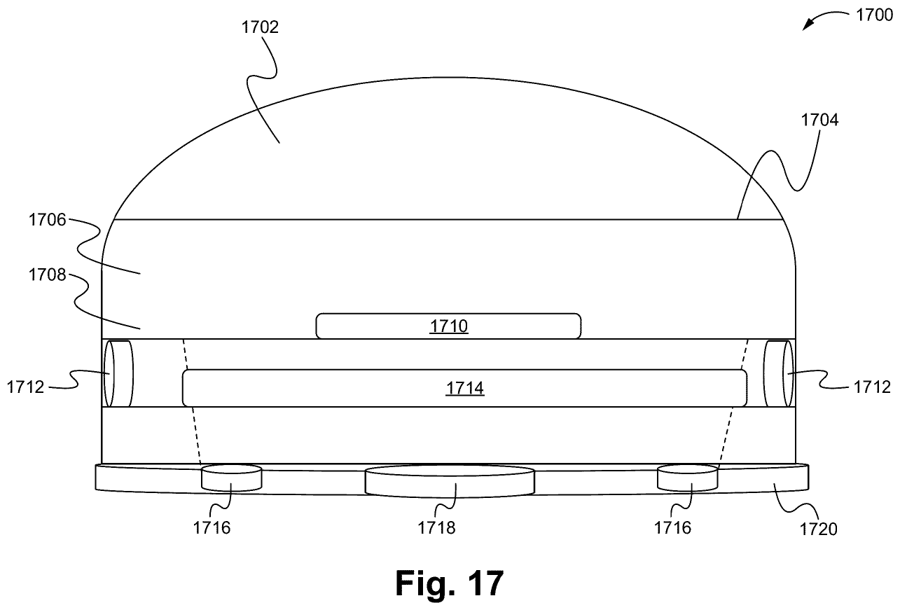

FIG. 17 illustrates a diagram of a sensor device according to some embodiments. The sensor device 1700 includes a curved solar cell 1702 (or a non-curved solar cell) and a sensor fusion SoM plus the PCB 1710. The sensor device 1700 includes an antenna ring 1706 and an insulation layer 1704. The sensor device 1700 also includes also a rack 1708, batteries 1714 and a heat sink 1720. One or more cameras 1712 are included (e.g., on opposite sides of the device to detect in different directions). The cameras 1712 are able to be configured to capture images in 360 degrees. Additionally, there are chemical sensors and acoustic sensors 1716 (e.g., on opposite sides of the device to detect in different directions). In some embodiments, the chemical sensors and acoustic sensors 1716 are a single device, and in some embodiments, they are separate devices. In some embodiments, there is also a clamp and base and a magnetic plate 1718. The magnetic plate 1718 is able to be used to attach the sensor device 1700 to a metal object (e.g., metal pipe). In some embodiments, a telescopic pole is also included. Although an exemplary sensor device is described, any design is possible. In some embodiments, the sensor device is approximately 5-10 centimeters. In some embodiments, the sensor device is larger or smaller than 5-10 centimeters.

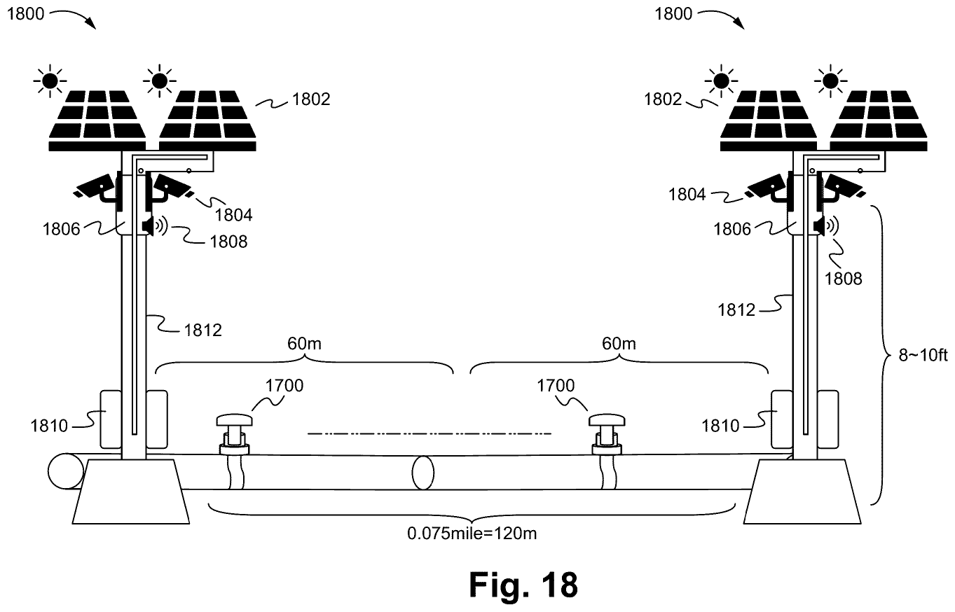

FIG. 18 illustrates a side view of a system for deployment of the sensor devices and edge AI server for monitoring according to some embodiments. The edge AI server 1800 is positioned (e.g., every 120 meters). In some embodiments, a server 1806 is positioned on a pole 1812 with a solar panel 1802 for providing power to the server 1806 and other devices. One or more batteries 1810 are also able to provide power (e.g., at night). In some embodiments, one or more cameras 1804 (e.g., 1, 2 or 4) are positioned on the pole 1812 with the server 1806 for 360 degree monitoring. Additionally, one or more loudspeakers 1808 are included. The server 1806 includes a processor (e.g., Qualcomm's SA490 chip) to process the cameras 1804 and any data that is coming from the devices. The server 1806 is positioned for object detection (e.g., 120 meters apart).

In some embodiments, there are redundancies in case one or more edge AI servers fail. Alerts and warnings are able to be implemented to indicate pending, imminent or actual device failures. If some of the edge AI servers are failing, at least if one is failing, by deploying a mesh network, it is still possible for one of the devices (e.g., sensor device or edge AI server) to reroute the data to another edge AI server so that the data is still processed. For example, if sensor devices 1-10 communicate with edge AI server A, but edge AI server A fails, then sensor devices 1-10 fall back to communicate with edge AI server B. In some embodiments, the fallback edge AI server is one of the nearest servers to the sensor devices. In some embodiments, analysis is performed to determine what is the closest edge AI server to each sensor device, and the sensor devices then communicate with that edge AI server device. Any form of redundancy is able to be implemented such that the sensor devices are always or almost always able to communicate with an edge AI server.

The edge AI servers 1800 are able to be positioned with sensor devices 1700 between each edge AI server 1800. As described, the sensor devices 1700 are attached to a pipe. In some embodiments, the sensor devices 1700 are attached to the pipe using a magnet.

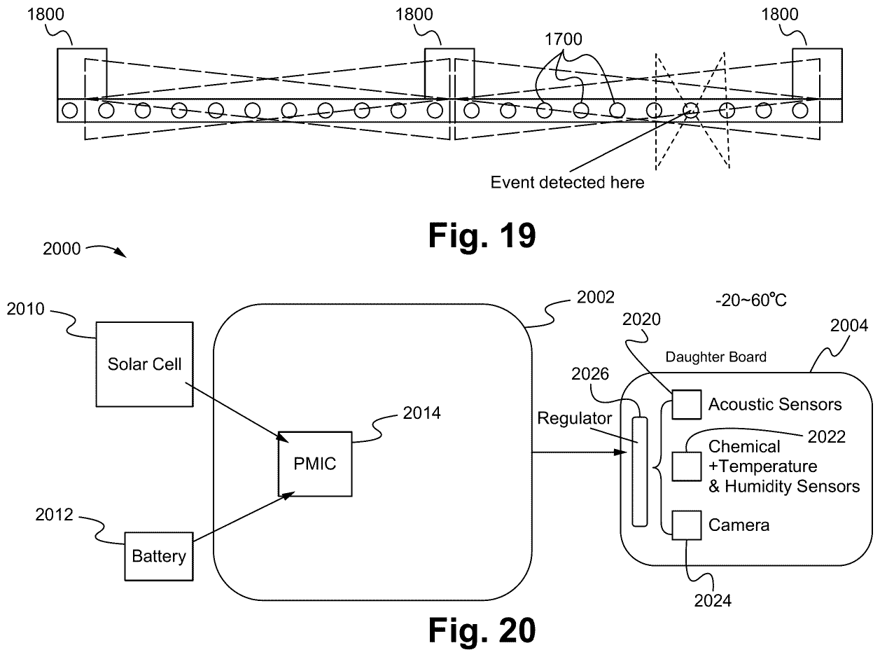

FIG. 19 illustrates a top view of a system for deployment of the sensor devices and edge AI server for monitoring according to some embodiments. In the system, edge AI servers 1800 are positioned approximately 120 meters apart with many sensor devices 1700 between each edge AI server 1800. For example, the sensor devices 1700 are spaced 1 meter apart. The acoustic sensors of each sensor device 1700 detect noises in all directions. Nano sensors have two MEMS cameras (or more) pointed along the pipe to take photos when an event is detected. The edge AI servers 1800 have two (or more) always-on security cameras to watch over the pipeline. The view shows an exemplary event detected by one or more sensor devices 1700 which is also in view of one or two of the edge AI servers 1800.

One benefit of having multiple devices in close proximity (e.g., sensor devices approximately 1 meter apart) is that if multiple sensor devices detect an issue, then the chances of a false positive are much lower than if a single device detects the issue, which means accuracy and confidence are much higher. Higher accuracy and confidence are important because once an issue is detected additional steps are taken such as deploying a drone, robot or human operator to address the issue immediately. In some embodiments, the data is stored on the sensor device such that if it is not able to communicate the data to an edge AI server, the data is able to be retrieved at a later date/time (e.g., manually for forensic purposes).

The system is able to perform non-stop security services with persistent monitoring (e.g., see, hear, and smell). Alerts are able to be sent when events of interest are detected. For example, an alert is sent to a security operations center. The security operations center is able to determine a security threat based on AI analysis of the sensor fusion data. A response to the security threat is able to include audible alarms, lights being turned on, drones and/or robots dispatched to the area. The drones and/or robots are able to bring further deterrents (e.g., loudspeakers, sirens, paintballs). The AI is able to generate a post-incident report based on the information gathered from any and all of the devices of the system.

The system is also able to autonomously perform predictive maintenance such as solar panel cleaning and sensor module with battery replacement. The solar panel is able to be cleaned by a drone or robot based on AI monitoring historical solar panel power output data, where the maintenance drone is deployed to panel locations to clean the solar panels with a cleaning solution. The sensor module replacement is based on AI monitoring of sensor battery level historical data, where maintenance robots or drones are deployed to replace the sensor modules and/or the sensor module batteries. The AI is able to generate a post-incident report after solar panel cleaning and sensor module replacement.

The system is also able to autonomously perform a repair. The edge AI confirms a leak, then a maintenance robot or drone is dispatched. If the robot or drone is capable of performing the repair, then it does. The AI generates a repair report. In some embodiments, a human is involved in the verification and repair. Real-time data is sent from a security operations center to a human in the field. The robots and drones are able to support inspection and perform pre-repair tasks.

FIG. 20 illustrates a diagram of a system-on-module according to some embodiments. A sensor unit powertrain 2000 includes a System-on-Module (SoM) 2002 and a daughter board 2004. The SoM 2002 includes a solar cell 2010, a battery 2012 and a Power Management Integrated Circuit (PMIC) 2014. The SoM 2002 is powered directly by the solar cell 2010 in the daytime and the battery 2012 at night. The battery 2012 is generally charged from 70-80% at all times.

The SoM is able to implement an advanced smart camera encompassing machine learning, edge computing, sensor processing, and integrated wireless connectivity. The SoM enables computing for on-device camera processing and machine learning across a wide range of applications. An Image Signal Processor (ISP) and an AI engine are integrated, along with a heterogeneous compute architecture including optimized custom Central Processing Unit (CPU), Graphics Processing Unit (GPU) and Digital Signal Processor (DSP) for accelerated AI performance.

The daughter board 2004 includes an acoustic sensor 2020, chemical, temperature and humidity sensors 2022 and a camera 2024, which all feed into a regulator 2026. The acoustic sensor 2020, chemical, temperature and humidity sensors 2022 and camera 2024 are implemented and function as described herein.

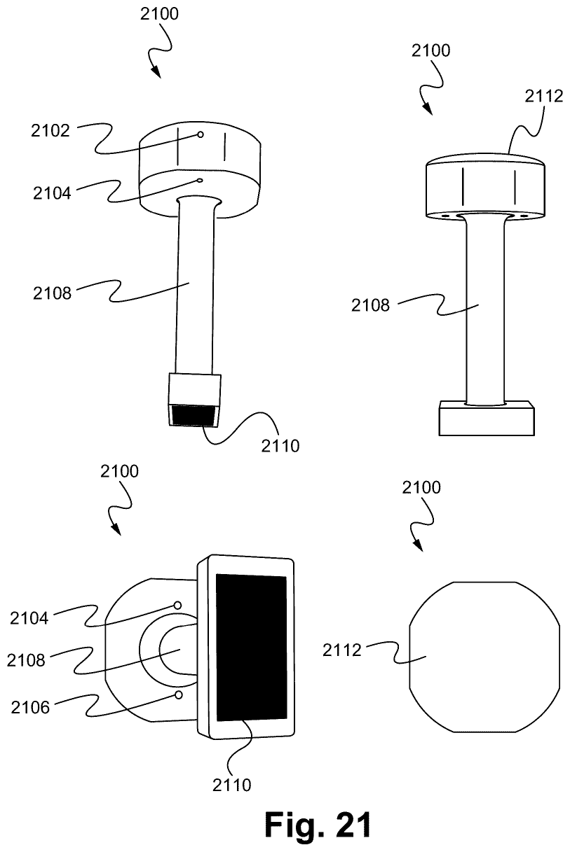

FIG. 21 illustrates views of a sentinel enclosure according to some embodiments. The sentinel enclosure 2100 includes the sensor device which has a camera 2102, an acoustic sensor and a chemical sensor. The sentinel enclosure 2100 includes one or more acoustic sensor holes 2104 and one or more chemical sensor holes 2106. In some embodiments, the sentinel enclosure 2100 includes a pole 2108, and on the bottom of the pole is a base with a magnet 2110. The magnet 2110 is able to be used to affix the sentinel enclosure 2100 to a metallic object. A solar panel 2112 is positioned on the top of the sentinel enclosure 2100. Fewer or additional components described herein are able to be included within the sentinel enclosure 2100.

A security operations center is able to show a health status of each device and a map for different regions of the sensors. The center is also able to be used for dispatching drones, robots and humans. In some embodiments, the drones and/or robots are autonomous and able to be dispatched without user involvement. Any information related to the system (e.g., from the sensor devices, edge AI servers, cloud devices) is able to be viewed using the security operations center.

The system also implements cybersecurity at every level. For example, various forms of security are implemented at the sensor devices, the edge AI servers, the cloud devices, and any communications among the devices.

The present invention has been described in terms of specific embodiments incorporating details to facilitate the understanding of principles of construction and operation of the invention. Such reference herein to specific embodiments and details thereof is not intended to limit the scope of the claims appended hereto. It is readily apparent to one skilled in the art that other various modifications can be made in the embodiment chosen for illustration without departing from the spirit and scope of the invention as defined by the claims. Features in various examples or embodiments are applicable throughout the Present Specification.

What is claimed is:

1. A method of Artificial Intelligence (AI)-enhanced security monitoring comprising:
implementing one or more sensor devices to acquire sensor information;
transmitting the acquired sensor information to a local server;
analyzing the acquired sensor information with the local server utilizing AI, wherein analyzing includes:
detecting an occurrence of an incident-of-interest;
classifying the occurrence of the incident-of-interest;
performing sensor localization; and
performing incident localization;
acquiring video information;
fusing the acquired sensor information with the acquired video information to generate fused information;
sending the fused information to a cloud device; and
triggering an alert.

2. The method of claim 1 wherein the one or more sensor devices comprise one or more cameras, one or more acoustic sensors and one or more nano/micro chemical sensors.

3. The method of claim 1 wherein each of the one or more sensor devices comprises a sentinel node.

4. The method of claim 1 wherein each of the one or more sensor devices comprises a System-on-Module.

5. The method of claim 1 wherein the acquired sensor information includes one or more images, acoustic information and/or chemical information, further wherein the acoustic information and/or chemical information are fused together.

6. The method of claim 5 wherein the one or more images are acquired when triggered based on the acoustic information and/or chemical information.

7. The method of claim 1 wherein metadata is included with the fused information.

8. The method of claim 1 wherein the cloud device combines the fused information from a plurality of local server devices.

9. The method of claim 1 wherein triggering the alert includes triggering a robot, drone or human operator to respond.

10. The method of claim 9 wherein the robot or drone includes an additional sensor device, and the human operator wears a wearable sensor device.

11. The method of claim 1 wherein the cloud device is configured to provide a situational assessment and an incident report.

12. The method of claim 1 wherein the method is utilized for: detecting a chemical leak, detecting a fire, detecting smoke, performing security and safety screening, military purposes, medical diagnostics, environmental monitoring, detecting greenhouse gases, detecting an earthquake, detecting a volcanic eruption, and monitoring ocean and marine life.

13. A system comprising:
one or more sensor devices, wherein each sensor device of the sensor devices includes a camera device, an acoustics sensor, and a nano/micro chemical sensor, wherein the camera device is triggered by the acoustics sensor and/or the nano/micro chemical sensor, wherein each sensor device fuses information from the camera device, the acoustics sensor and/or the nano/micro chemical sensor to generated fused sensor information;
one or more local Artificial Intelligence (AI) server devices configured for:
communicating with the one or more sensor devices including receiving the fused sensor information;
processing the fused sensor information with AI;
implementing one or more second camera devices to acquire a video if an issue is detected within the fused sensor information;
fusing the fused sensor information with the video to generate fused server information; and
one or more cloud devices configured for:
receiving the fused server information; and
processing the fused server information.

14. The system of claim 13 wherein the one or more sensor devices communicate with a designated one local AI server device of the one or more local AI server devices via one or more wireless communication networks.

15. The system of claim 13 wherein the one or more sensor devices are stationary.

16. The system of claim 15 wherein the one or more sensor devices are magnetically affixed to an object.

17. The system of claim 13 wherein the one or more sensor devices are mobile.

18. The system of claim 17 wherein the one or more sensor devices include a drone, an unmanned aerial vehicle, a robot or a satellite.

19. The system of claim 13 wherein the one or more sensor devices are wearable.

20. The system of claim 19 wherein the one or more sensors comprise a bi-directional video camera, an acoustic sensor, or a wearable nano/micro chemical sensor.

21. The system of claim 13 wherein the one or more sensor devices are spaced at a pre-determined distance.

22. The system of claim 13 wherein the one or more local AI server devices are spaced at a pre-determined distance.

23. The system of claim 13 wherein the one or more local AI server devices are configured for triggering an alert.

24. The system of claim 13 wherein the one or more cloud devices are configured for triggering an alert.

25. The system of claim 13 further comprising one or more response devices configured for responding to an alert.

26. The system of claim 23 wherein the one or more response devices include a drone, unmanned aerial vehicle, or a robot.

27. A server device comprising:
one or more camera devices configured to acquire a video;
a non-transitory memory for storing an application, the application configured for:
communicating with one or more sensor devices including receiving fused sensor information;
processing the fused sensor information with Artificial Intelligence (AI);
fusing the fused sensor information with the video to generate fused server information; and
communicating the fused server information with one or more cloud devices;
a processor coupled to the memory, the processor configured for processing the application.

28. The server device of claim 25 wherein the one or more camera devices are positioned to face in multiple directions.

29. The server device of claim 26 wherein the one or more camera devices are configured to acquire the video in 360 degrees.

30. The server device of claim 25 wherein the application is further configured for triggering an alert.

31. The server device of claim 28 wherein triggering the alert includes causing a drone, unmanned aerial vehicle, robot or human to respond to the alert.

32. The server device of claim 25 wherein the server device comprises a local server device.
